(19) United States
(12) Patent Application Publication
(10) Pub. No.: US 2001/0051195 A1
(43) Pub. Date: Dec. 13, 2001

(54) Methods and compositions for increasing fermentation of a microorganism

(76) Inventors: Dusan A. Miljkovic, San Diego, CA (US); Jovan D. Hranisavljevic, Belgrade (YU); Fessenmaier Martin, Aliso Viejo, CA (US)

Correspondence Address: FISH & ASSOCIATES, LLP, 1440 N. HARBOR BLVD., SUITE 706, FULLERTON, CA, 92835, US

(21) Appl. No.: 09/802,349

(22) Filed: Mar. 8, 2001

Related U.S. Application Data
(60) Provisional application No. 60/187,626, filed on Mar. 8, 2000.

(51) Int. Cl. C12C 11/00

(52) U.S. Cl. 426/11; 426/49

(57) ABSTRACT

A composition comprises a bioactive compound that increases the rate of fermentation of a microorganism, wherein the bioactive compound binds to a thaumatin-like protein. Particularly contemplated bioactive compounds are prepared from plants of the family poaceae, have a molecular weight of no more than 1000 Da, and have a UV absorption maximum of about 260 nm.

### FIELD OF THE INVENTION

The field of the invention is fermentation of microorganisms.

### BACKGROUND OF THE INVENTION

Fermentation is one of the oldest biotechnological processes in which a naturally occurring or synthetic raw material is converted towards a more desirable product, and most fermentation processes employ microorganisms or extracts and components thereof. For example, malt sugars are converted into alcohol by yeast in the process of beer brewing. Other fermentation processes utilize yeast cell suspensions to generate carbon dioxide for raising dough during a bread baking process. Still other fermentations employ bacteria or microbial enzymes to convert toxic waste into less toxic fermentation products.

In order to increase the amount of desired fermentation product, various methods are known in the art. One method of increasing the amount of desired fermentation product is to increase the amount of fermenting cells or fermenting enzyme(s). Although technically relatively simple, increasing the amount of biocatalyst is frequently not practicable because the high amount of the biocatalyst tends to interfere with the quality of the desirable product.

In another method, physicochemical parameters may be changed to improve the amount of desired fermentation product. For example, U.S. Pat. No. 4,95,505 to Cho describes a fermentation of a microorganism under elevated pressure conditions, and temperature control in a particular temperature range. Alternatively, fermentation conditions may be altered to include a higher oxygen level by increasing oxygen feeding, stir rate, etc. Although over-all yields of desirable products may be increased by stringent control of physicochemical parameters, stringent control typically demands relatively expensive equipment and maintenance.

In still another method, additives may be included to the fermentation process to stimulate the fermentation of a microorganism. For example, in U.S. Pat. No. 5,36,639 to Griffith et al., the inventors disclose a method to increase anaerobic fermentation rates by addition of condensed phosphates. Although the production of alcohol from sugar increases, macronutrient elements have to be added in an excessive amount to compensate for the elements sequestered by the condensed phosphates, thereby raising cost and potentially compromising quality of the fermentation product. In yet another example, U.S. Pat. No. 5,486,367 to Fung, an oxygen reactive enzyme is added to a fermentation process to accelerate the fermentation of comestible products. Fung's system allows a relatively wide flexibility in various applications, however, requires relatively expensive enzyme preparations.

Although various methods are known in the art to increase fermentation of a microorganism, all or almost all of them suffer from one or more disadvantages. Therefore, there is still a need to provide compositions and methods to increase fermentation of a microorganism.

### SUMMARY OF THE INVENTION

The present invention is directed to compositions and methods of increasing fermentation of a microorganism. More particularly, a composition comprises a bioactive compound that increases the rate of fermentation of a microorganism, wherein the bioactive compound binds to a thaumatin-like protein.

In one aspect of the inventive subject matter, the bioactive compound is prepared from a plant, preferably from a poaceae, and even more preferably from Hordeum vulgare. Particularly contemplated isolation protocols include malting, mashing, anion exchange chromatography, or ultrafiltration, however, salt-, buffer- and alcohol extractions are also suitable.

In another aspect of the inventive subject matter, the bioactive compound has a molecular weight of no more than 100 Da and a UV absorption maximum of about 260 nm. While it is generally preferred that the bioactive compound is isolated from a plant, partial or de novo synthesis is also contemplated.

In a further aspect of the inventive subject matter, a method of increasing fermentation of a microorganism has one step in which a composition is provided that comprises a bioactive compound that binds to a thaumatin-like protein and increases the rate of fermentation of a microorganism. In a further step, the composition is presented to the microorganism in an amount effective to increase the fermentation of the microorganism.

Contemplated fermentations preferably comprise utilization of a saccharide, more preferably a monosaccharide, and most preferably α-D-glucose. While it is contemplated that fermentation of all microorganisms is increased by the composition, it is especially contemplated that the microorganism is a yeast, and preferably a Saccharomyces spec.

Various objects, features, aspects and advantages of the present invention will become more apparent from the following detailed description of preferred embodiments of the invention, along with the accompanying drawings

### BRIEF DESCRIPTION OF THE DRAWING

FIG. 1 is a graph depicting an exemplary procedure for preparation of contemplated compositions and bioactive compounds.

FIG. 2 is a graph depicting fermentation rates of yeast in a fermentation using contemplated compositions at anaerobic and aerobic conditions.

### DETAILED DESCRIPTION

As used herein the term “compound that binds to a thaumatin-like protein” refers to any compound or mixture of compounds that exhibit a binding preference to a thaumatin-like protein from barley of at least 10-fold, more preferably at least 100-fold over binding to other barley proteins, wherein binding of contemplated compounds to the thaumatin-like protein will preferably have a K_{D} of less than 10⁻³M, more preferably of less than 10⁻⁴M. The mode of binding need not be limited to a single interaction (e.g., hydrophobic interaction), but may include multiple interactions (e.g., electro-static interactions and hydrogen bonding, etc.). It is especially contemplated that binding is reversible, however, irreversible binding is not excluded. Although thaumatin-like proteins from barley are generally preferred binding partners for compounds according to the inventive subject matter, thaumatin-like proteins from alternative sources, including microorganisms, plants, and animals are also contemplated. Thaumatin-like proteins are a well characterized class of polypeptides and are described, for example, in Cvetkovic et al., J. Serb Chem. Soc. 62(9):777-786 (1997), Cvetkovic et al., J. Serb. Chem. Soc. 62(1):51-56 (1997) and Cvetkovic et al., J. Inst. Brew. 103:183-186(1997), all of which are incorporated by reference herein.

As also used herein the term “fermentation” refers to a process in which one or more substrates are converted by a microorganism or extract of a microorganism to a product, wherein either the product or a byproduct of the process is a desirable compound. For example in the process of sugar degradation utilizing a yeast or bacterium, glucose or other saccharides are a substrate, the process is glycolysis (either anaerobic or aerobic), and the desired product is ethanol and/or methanol. In another example, in the process of bread baking, the microorganism is yeast, the substrate includes simple and complex carbohydrates, and the byproduct is CO₂. Of course a combination of desirable product and byproduct are also contemplated, and may include a beer brewing process in which ethanol and CO₂ are the desirable product and byproduct. Contemplated fermentations may be performed utilizing living cells, dormant cells (e.g., freeze-dried cells), or cell extracts. Consequently, the term “increasing fermentation” refers to an increase of a product or byproduct in a fermentation reaction with contemplated compositions/bioactive compounds relative to a fermentation under comparable conditions without contemplated compositions/bioactive compounds.

As further used herein the term “microorganism” refers to prokaryotic and eukaryotic cells, which grow as single cells, or when growing in association with other cells, do not form organs. Especially contemplated microorganisms include bacteria, yeast, molds, and fungi.

It is generally contemplated that compositions according to the inventive subject matter comprise a bioactive compound that increases a rate of fermentation of a microorganism, wherein the bioactive compound binds to a thaumatin-like protein. Consequently, a method of increasing a fermentation of a microorganism includes one step in which a bioactive compound is provided that binds specifically to a thaumatin-like protein. In a further step, the bioactive compound is presented to a microorganism in an amount effective to increase fermentation of the microorganism.

In a preferred aspect, the composition is prepared from Hordeum vulgare as described below, and admixed in a single dose of 500 mg per liter of fermentation volume, wherein the fermentation is an anaerobic glucose fermentation of Saccharomyces spec.

In alternative aspects of the inventive subject matter, it is contemplated that appropriate compositions and bioactive compounds need not be limited to a preparation from Hordeum vulgare, but may also include preparations from various plants other than Hordeum vulgare, and particularly contemplated alternative plants include Hordeum spec., and members of the poaceae family. While the preparation of contemplated compositions and/or bioactive compounds is preferably from plant extracts, it should further be appreciated that contemplated compositions and/or bioactive compounds may also be isolated from microorganisms (i.e., bacteria, fungi, yeasts, unicellular eucaryotic organisms) or animals, so long as contemplated bioactive compounds bind to a thaumatin-like protein and increase the fermentation of a microorganism.

It should further be appreciated that contemplated bioactive compounds may be isolated, purified to homogeneity, and the structure be elucidated. Consequently, it should be appreciated that contemplated bioactive compounds may be entirely (de novo) or partially synthesized/modified in vitro. For example, where contemplated compounds are partially synthesized, a precursor of contemplated compounds may be isolated from a plant or microorganism, and then be subjected to one or more steps to arrive at contemplated compounds. Alternatively, contemplated compounds may be modified in one or more synthetic steps to impart a particularly desirable physico-chemical property. For example, contemplated compounds may be esterified with a polar compound (e.g, polyethylene glycol) to increase water solubility. In another example, contemplated compounds may be coupled to a resin or other material to control the rate of release to the microorganism.

Preferred contemplated compounds have a relatively low molecular weight, typically no more than 1000 Da, however, it should be recognized that the molecular weight may vary considerably and will predominantly depend on the source from which the compound is isolated, synthetic modifications, dimerizations and multimerizations. Likewise, it is contemplated that suitable compounds need not be limited to compounds having a UV absorption maximum at about 260 nm (which is characteristic for contemplated compounds isolated using the procedure outlined below), and various spectral characteristics other than a UV₂₆₀ peak are also contemplated. Similarly, while contemplated compounds isolated from Hordeum vulgare are soluble in a lipophilic solvent at a concentration of at least 10 mg per milliliter, higher or lower solubilities are also contemplated and will typically depend on the source from which contemplated compounds are isolated, and/or on further chemical modifications of contemplated compounds. The term “lipophilic solvent” as used herein includes all solvents that have a miscibility with H₂O of less than 10 vol %.

While it is generally preferred that contemplated compounds are chemically substantially pure (i.e., concentration of contemplated compounds greater than 90 wt %, preferably greater than 95 wt %, most preferably greater than 99 wt %), it should also be appreciated that contemplated compounds may be coupled to one or more than one molecule, and particularly contemplated molecules include thaumatin-like proteins. Thus, contemplated compositions include complexes between contemplated compounds and thaumatin-like proteins, and especially include complexes between contemplated compounds and thaumatin-like proteins as they are isolated from the appropriate sources (infra).

With respect to the presentation of contemplated compositions and/or bioactive compounds to the microorganism it is contemplated that form and dosage may vary considerably. For example, where a sustained increase of fermentation is desired, or where the fermentation is a continuous fermentation, the administration of the composition may be a continuous administration. On the other hand, and especially where relatively small volumes of fermentation medium are employed, discontinuous administration may be preferable. With respect to the amount of contemplated compositions and/or bioactive compounds it is contemplated that suitable amounts may be in the range of about 1 mg/liter (and less where appropriate) to several 100 mg /liter, and even more. For example, where relatively high dosages are required, dosages may increase from 500 mg to 5 g per liter, and more. High dosages may also be required where the potency of the composition is relatively low. Likewise, in cases where low dosages are required, or the composition has a relatively high potency, dosages between 500 mg and 25 mg per liter, or less, are also appropriate. Therefore, it is generally contemplated and understood by those skilled in the art that among other parameters the particular microorganism, fermentation conditions and the potency of the composition will at least partially determine the nature of the administration. For example, where high dosages are to be administered, more than a single dosage is contemplated, including 2 to 6 dosages, and more. Where low dosages, especially dosages lower than 500 mg/liter are contemplated, single, bidaily, or less frequent administrations are appropriate.

Where the fermentation is not based in a fluid, (e.g., bread fermentation, bio-remediation), administration will be based on weight % rather than mg/l. Thus, contemplated administrations may also include additions of contemplated compounds in a range of 0.1 wt % to 50 wt %, and more, and it should be appreciated that such additions may further be in a solid form, or in dissolved form.

Particularly preferred uses of the method of increasing the fermentation of a microorganism according to the inventive subject matter includes fermentations in food processing (e.g., production of beer, wine, bread, etc.), industrial fermentation processes (e.g., meat, cereal-based products, dairy products, etc.) processes to produce alcohols (e.g., methanol, ethanol, etc.), detoxification processes utilizing microorganisms, microbial fermentation processes to produce non-recombinant and recombinant microbial products (antibiotics, proteins, etc) and so forth.

### EXAMPLES

The following examples provide various experimental procedures to isolate and use compounds according to the inventive subject matter. Examples 1 and 2 describe basic and improved procedures of producing compositions according to the inventive subject matter, respectively. The biological activity of the compounds isolated according to procedures in Examples 1 and 2 is described in Example 3.

### Example 1

Barley grains were malted according to procedures well known in the art of beer brewing (see e.g., Principles of Brewing Science, Second Edition, by George J. Fix; Brewers Publications; ISBN: 0937381748, or The Brewers' Handbook by Ted Goldhammer; KVP Publishers; ISBN: 0967521203). In order to extract soluble substances from the malt and to convert additional insoluble solids into soluble material through controlled enzymatic conversion, a step of mashing was subsequently applied to the ground malt (suspended in water) according to a typical brewer's schedule. The temperature cycles were as follows: Incubation at 40° C. for 60 min, incubation at 50° C. for 60 min, incubation at 60° C. for 60 min, incubation at 72° C. for 60 min, and incubation at 75°-80° C. for 60 min. Soluble portions of samples were separated from husks and other insoluble material and freeze-dried.

The freeze-dried barley extract obtained after mashing at 40° C. served as base for fractionation into its components. A first fractionation was achieved by preparative liquid chromatography using a DEAE-Sephacel column (2.6×20 cm) equilibrated with 50 mM phosphate buffer, pH 7.8. 150 mg of the freeze-dried sample was dissolved in 10 ml of buffer and placed on the column. A linear NaCl-gradient (0-0.5 M) was run at a flow rate of 10 ml/h. Fractions (2 ml each) were collected, and elution was monitored at 280 nm. The DEAE chromatography resulted in four distinct protein peak fractions: I-basic, II-neutral, III- and IV-acidic. Respective peak fractions were collected, desalted and concentrated by membrane ultra-filtration using a membrane cut-off pore size of 1000 Dalton, and concentrated corresponding fractions were checked for their capacity to influence yeast fermentation rate. The basic fraction I produced significant inhibitory effect (i.e., a reduction of the yeast fermentation rate), while the remaining three concentrated fractions were almost inert. As it could later be identified (data not shown), the main proteinaceous component in fraction I represent thaumatin-like proteins. It has been noticed during the membrane ultra-filtration of the pooled protein fractions I-IV (i.e., fractions obtained by ion exchange chromatography), that the filtrate of some fractions contains LMW (low molecular weight) substances with a UV absorbance maximum of approximately 260 nm. These observations prompted us to employ molecular sieving chromatography to separate these LMW substances from proteins in these fractions.

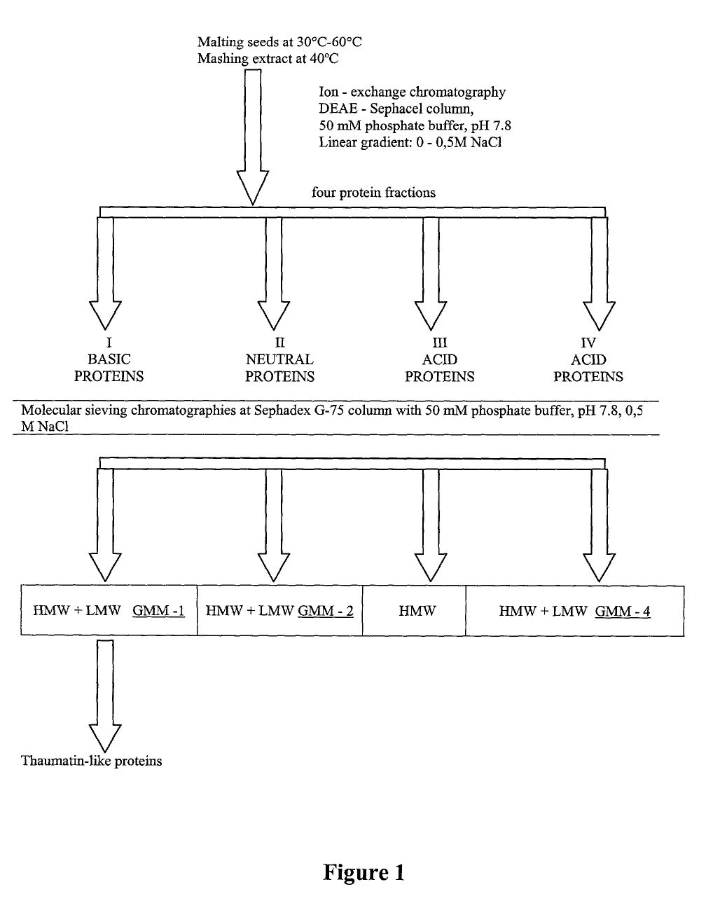

For that purpose, the four separated fractions by DEAE-Sephacel column I-IV were pooled and freeze-dried. Molecular sieving chromatography was performed on Sephadex G-75-50 column (2.8×80 cm) with 50 mM phosphate buffer, pH 7.8, containing 0.5 M NaCl (flow rate-12 mn/h, fractions 2 ml, elution recorded at 260 nm). LMW compounds with an absorbance near 260 eluted at relatively high elution volume. Where the separated fractions were individually subjected to molecular sieving on a Sephadex G-75-50 column, LMW compounds eluted near to the end of the separation, typically between 60th-80th fractions. These fractions were designated GMM-1, GMM-2 and GMM-4, and consist of LMW components. All of GMM-1, GMM-2 and GMM-4 increased the rate of yeast fermentation, and bound strongly and reversibly to thaumatin-like protein (bind to thaumatin-like proteins at low salt condition and release from thaumatin-like proteins at high salt condition). A typical isolation procedure is depicted in FIG. 1.

### Example 2

20 g of freeze-dried barley extract obtained after mashing at 40° C. was suspended in 80 ml of water and stirred over night at ambient temperature. The suspension was supplemented with 120 ml of 0.8 M NaCl solution and extraction was continued for 24 hours with stirring. An aqueous extract was separated from the suspension by vacuum filtration over a cellulose filter pad.

The filtered extract was freeze-dried or vacuum-evaporated. So obtained dry malt extract (yield approx. 12-14 g) contained 5.6 g of NaCl originating from the extracting solvent and a complex mixture of water soluble barley components. The filtered freeze-dried extract was purified by extraction with two 50 ml portions of warm ethanol under vigorous mixing for two hours, The ethanolic extracts were filtered, combined, and evaporated to an oily residue in vacuum. The oily residue was re-dissolved in 15 ml of water and freeze-dried, resulting in a hard glassy yellowish product in a total amount of approximately 3 g.

The glassy yellowish product increased the rate of yeast fermentation, and bound strongly and reversibly to thaumatin-like protein (bind to thaumatin-like proteins at low salt condition and release from thaumatin-like proteins at high salt condition).

Thus, it should be recognized that contemplated compositions comprise a plant seed extract (preferably from Hordeum vulgare), wherein the plant seed is malted (preferably at a temperature between about 30° C. and 65° C.) and the extract is prepared from the malted plant seed using a protocol that includes an aqueous extraction step (e.g., using an aqueous buffer such as a citrate buffer), and that the extract increases the fermentation rate of a microorganism when the extract is administered to the microorganism at a concentration effective to increase the fermentation rate.

### Example 3

The biological activity of LMW fractions from Example 1 (GMM-1, GMM-2 and GMM-4) and the glassy yellowish product from Example 2 was monitored by quantification of brewers' yeast fermentation rate under anaerobic conditions using a modified Warburg method (Mirsky, N. et al., J. Inorg. Biochem. 13(1):11-21 (1980), which is incorporated by reference herein.

Two grams of wet brewers yeast cells (about 20% dry weight) were suspended in fermentation medium (25 ml of 60 mM phosphate buffer, pH 5.7 and 10 ml of 5% (w/v) glucose solution), and aliquots of the products from example 1 or 2 were added to the fermentation medium for testing. Incubations were carried out in 50 ml fermentation flasks at 25° C. for 60 minutes. The fermentation rates were measured from the volume of generated CO₂. All of the tested LMW fractions or the product from Example 2 showed significant biological activity or bioactivity in that they increased the yeast fermentation rate in the range of about 20-40%.

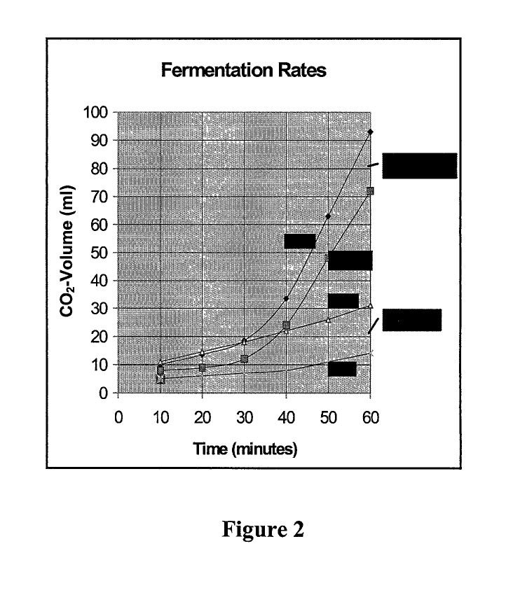

In a further experiment, the activity of GMM-2 was checked in aerobic conditions. Despite general restriction of yeast fermentation caused by combined effects of NaCl from buffer and air oxygen (Pasteur effect), the relative amount of generated CO₂ was doubled in comparison to the included control. The comparative results for GMM-2 fraction at anaerobic and aerobic conditions are shown in FIG. 2. The results conclusively prove modulating activity of the isolated LMW substances on yeast metabolism, as evidenced by comparison to control. Consequently, it should be appreciated that contemplated bioactive compounds increase fermentation of a microorganism at least 5%, more typically at least 10%, even more typically at least 15-35%, and more.

Thus, specific embodiments and applications of a metabolic modulator have been disclosed. It should be apparent, however, to those skilled in the art that many more modifications besides those already described are possible without departing from the inventive concepts herein. The inventive subject matter, therefore, is not to be restricted except in the spirit of the appended contemplated claims. Moreover, in interpreting both the specification and the contemplated claims, all terms should be interpreted in the broadest possible manner consistent with the context. In particular, the terms “comprises” and “comprising”, should be interpreted as referring to elements, components, or steps in a non-exclusive manner, indicating that the referenced elements, components, or steps may be present, or utilized, or combined with other elements, components, or steps that are not expressly referenced.

We claim:

1. A composition comprising a bioactive compound that increases a rate of fermentation of a microorganism, wherein the bioactive compound binds to a thaumatin-like protein.

2. The composition of claim 1 wherein the bioactive compound is prepared from a plant.

3. The composition of claim 2 wherein the plant is a poaceae.

4. The composition of claim 2 wherein the plant is Hordeum vulgare.

5. The composition of claim 3 wherein the plant is extracted using a protocol comprising at least one of a step of malting, a step of mashing, a step of anion exchange chromatography, and a step of ultra-filtration.

6. The composition of claim 3 wherein the plant is extracted using a protocol comprising at least one of a step of extraction of a barley preparation in a NaCl solution, and ethanol extraction.

7. The composition of claim 1 further comprising a tocol.

8. The composition of claim 1 wherein the bioactive compound is synthetic.

9. The composition of claim 1 wherein the bioactive compound has a molecular weight of no more than 1000 Da and has an UV absorption maximum of about 260 nm.

10. The composition of claim 1 wherein the fermentation comprises utilization of a saccharide.

11. The composition of claim 1 wherein the microorganism is a yeast.

12. A composition comprising:
a plant seed extract, wherein the plant seed is malted and the extract is prepared from the malted plant seed using a protocol that includes an aqueous extraction step; and
wherein the extract increases a rate of fermentation in a microorganism when the extract is presented to the microorganism at a concentration effective to increase the rate of fermentation.

13. The composition of claim 12 wherein the plant seed is a Hordeum vulgare seed.

14. The composition of claim 12 wherein the malting is performed at a temperature between 30° C. and 65° C.

15. The composition of claim 12 wherein the extraction step includes extraction with an aqueous buffer.

16. The composition of claim 12 wherein the extract has a molecular weight of no more than 1000 Da and has a UV absorption maximum at about 260 nm.

17. A method of increasing a fermentation of a microorganism, comprising:
providing a bioactive compound that binds specifically to a thaumatin-like protein; and
presenting the bioactive compound to the microorganism in an amount effective to increase the fermentation of the microorganism.

18. The method of claim 17 wherein the fermentation comprises utilization of a monosaccharide.

19. The method of claim 17 wherein the microorganism is a yeast.

20. The method of claim 17 wherein the bioactive compound is prepared from Hordeum vulgare using a protocol comprising at least one of a step of malting, a step of mashing, a step of anion exchange chromatography, a step of salt extraction, a step of buffer extraction, and a step of ultrafiltration.
